(19) United States
(12) Patent Application Publication
(10) Pub. No.: US 2014/0212857 A1
(43) Pub. Date: Jul. 31, 2014

(54) GENERATING A WORKOUT ROUTINE

(71) Applicant: HybridMedia LLC, Cleveland, OH (US)

(72) Inventors: Patrick Sullivan, Cleveland, OH (US); Reid Sheppard, Kirtland, OH (US)

(21) Appl. No.: 14/164,411

(22) Filed: Jan. 27, 2014

Related U.S. Application Data
(60) Provisional application No. 61/756,726, filed on Jan. 25, 2013.

(51) Int. Cl. G06F 19/00

(52) U.S. Cl. CPC G06F 19/3481
USPC 434/247

(57) ABSTRACT

One or more systems and/or techniques are provided for generating a workout routine. For example, a first input including a first tool available to a user and/or a second input including a modality may be received. A set of movements may be generated based upon the first tool and/or the modality. A workout routine may be generated based upon the set of movements. The workout routine can be generated based upon a selection of one or more movements from the set of movements. In an example, the one or more movements are randomly selected from the set of movements. The results of the workout routine may also be tracked.

### BACKGROUND

Exercise is used to maintaining a healthy lifestyle and an individual's physical and mental well-being. Accordingly, many individuals participate in workout routines. Workout routines are often tailored to a fitness level of an individual and are aimed at assisting the individual to achieve one or more fitness or exercise goals.

Fitness experts, such as trainers and coaches, often assist individuals in developing workout routines appropriate for the individual fitness level and their specific goals. However, hiring such professionals can be expensive and individuals may not always have access to a fitness expert when needed. In this regard, individuals with busy schedules and who travel frequently may find it hard to stick with a set program and/or find the time to make it to a workout facility on a regular basis. Furthermore, many individuals find it challenging to follow a set workout routine while traveling given the variability of the equipment available while away. Thus, while traveling, individuals may require multiple different workout routines.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or methods for generating a workout routine are provided. According to some aspects, a method of generating a workout routine based upon tools (e.g. equipment, etc.) available to a user is provided. In some embodiments, user input specifying one or more tools, such as various equipment available to the user, may be received (e.g., through a mobile device, a cell phone, a fitness device, a tablet, or any other device). A set of movements, which may be performed by the user using the one or more tools, may be generated based upon the user input. The set of movements can also be configured based upon a modality that the user inputs (e.g., a gymnastic movement, a weightlifting movement, a metabolic movement, etc.). Once the set of movements is configured based upon the user input, a workout routine can be generated based on the set of movements.

According to some aspects of the instant disclosure, a method for generating a workout routine is provided. The method comprises receiving a first input, generating a set of movements and generating a workout routine based upon the set of movements. The first input may comprise a first tool available to a user. The generating of the set of movements may be based upon the first tool available to the user. In some embodiments, a second and/or a third input may be received and used to generate the set of movements.

According to another aspect of the instant disclosure, a system for generating a workout routine is provided. The system for generating the workout routine comprises a workout generator component. The workout generator component is configured to receive a first input comprising a first tool available to a user and a second input comprising a modality and/or a geographic location of the user. The workout generator component may be configured to generate a set of movements based upon the first tool, the modality, and/or the geographic location. The workout generator may be configured to generate a workout routine based upon the set of movements.

According to another aspect of the instant disclosure, a computer readable medium comprising instruction that when executed perform a method of generating a workout routine is provided. The method comprising receiving a first input comprising a first tool available to a user, receiving a second input comprising a modality, generating a set of movements based upon the first tool and the modality and generating a workout routine based upon the set of movements.

### DESCRIPTION OF THE DRAWINGS

Aspects of the disclosure are understood from the following detailed description when read with the accompanying drawings. It will be appreciated that elements and/or structures of the drawings are not necessarily be drawn to scale. Accordingly, the dimensions of the various features may be arbitrarily increased and/or reduced for clarity of discussion.

FIG. 1 is a flow diagram illustrating an exemplary method of generating a workout routine, according to some embodiments.

FIG. 2 is a flow diagram illustrating an exemplary method of generating a workout routine, according to some embodiments.

FIG. 3 is a component block diagram illustrating an exemplary system for generating a workout routine, according to some embodiments.

FIG. 4 is an illustration of a block diagram illustrating a component of an exemplary system, according to some embodiments.

FIG. 5 is an illustration of a block diagram illustrating a component of an exemplary system, according to some embodiments.

FIG. 6 is an illustration of a block diagram illustrating a component of an exemplary system, according to some embodiments.

FIG. 7 is an illustration of an exemplary computer readable medium wherein processor-executable instructions configured to embody one or more of the provisions, according to some embodiments.

FIG. 8 illustrates an exemplary computing environment wherein one or more of the provisions, according to some embodiments.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It is evident, however, that the claimed subject matter can be practiced without these specific details. In other instances, structures and devices are illustrated in block diagram form in order to facilitate describing the claimed subject matter.

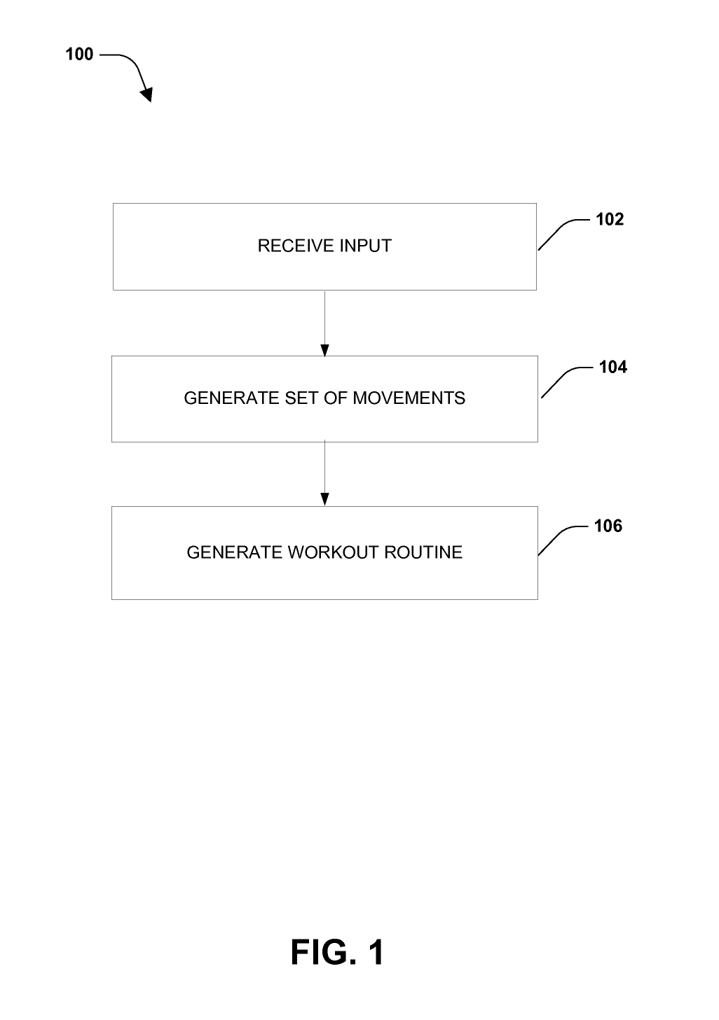

FIG. 1 illustrates a method 100 for generating a workout routine. At 102, a first input is received. In some embodiments, the first input includes a first tool, a second tool, and/or other tools available to a user. In some embodiments, at least one of the first tool or the second tool is a dumb bell, bike, jump rope, dip belt, elevated surface, kettlebell, medicine ball, parallettes, sled, sledge hammer, rope, barbell, plates, rower, Bulgarian bag, sand bag, slam ball, pull-up bar, gymnastic rings, stretch bands, abdominal mats, stones, tires, glute-ham developer (GHD), and/or a variety of other tools. In some embodiments, the first input may be received through an interface (e.g., a user interface, such as an app). The interface may be accessible on various devices, such as computers, cell phones, tablets, watches, or the like. In some embodiments, the interface can be accessed as an application, a mobile app, a website, a web service, a cloud service or the like.

In some embodiments, a second input and/or a third input is received. In some embodiments, the second input can be a modality. The modality may comprise a gymnastic movement, a weightlifting movement, a metabolic movement, etc. In some embodiments, the third input can be a geographic location of a user. The geographic location of the user can be configured to provide data such as nearby running trails, tracks, pools, swimming areas, hills, obstacle courses, rock walls and the like. The geographic location may also correspond to a fitness facility. In some embodiments, by selecting a specific fitness facility, the tools available at that specific fitness facility are automatically inputted as being available to the user.

At 104, a set of movements is generated. In some embodiments, the set of movements may be generated based upon the first tool, the second tool, the modality, and/or the geographic location of the user. In some embodiments, set of movements can be provided as a list (e.g., a selectable list, such that the user may select one or more movements from the selectable list to create a workout). In some embodiments, the set of movements is populated with movements that can be performed using the first tool and/or the second tool. For example, if the user inputs that a barbell and weights are available, the set of movements may include movements, such as back squats, front squats, overhead squats, hang cleans, power cleans, squat cleans, strict presses, push presses, push jerks, split jerks, thrusters, power snatches, squat snatches, hang snatches, clean and jerks, high pulls, deadlifts, sumo deadlift high pulls, Romanian deadlifts standing rows, bent-over rows, bear complexes, lunges, Turkish getups, bench press, curls, skull crushers, tricep extensions, shrugs, good mornings and/or the like.

The set of movements can also include movements that do not require a tool, such as a body weighted movements. For example, the set of movements can include pushups, jumping knee tucks, broad jumps, sit-ups, crunches, planks, pistols, hollow rocks, air squats, jumping air squats, stationary lunges, walking lunges running, bear crawls, burpees, burpee broad jumps, handstand walks, handstand push-ups, wall walks, wall sits, yoga position and/or the like.

In some embodiments, the set of movements is generated based upon the modality. For example, if the modality selected is gymnastic, the set of movements will be populated with gymnastic movements that can be performed based upon the tools, if any, available to a user. By way of example, when the modality selected is gymnastics, the set of movements may include muscle-ups, walking hand stands, kipping pull-ups, butterfly pull-ups, L-sits, knees to elbows, rope climb, toes-to-bar, v-ups, skin the cats and/or the like. In yet another example, if the modality selected is metabolic, the set of movements will be populated with metabolic movements, such as running, swimming, rowing, cycling and the like.

In some embodiments, the set of movements may be generated based upon the geographic location of the user. For example, if the user is near a beach, the set of movements may include beach running, swimming or the like.

At 106, the workout routine is generated based upon the set of movements. In some embodiments, the workout routine is generated based upon a selection a first movement, a second movement, and/or other movements from the set of movements. In another embodiment, the workout routine is generated based upon a randomized selection of the first movement, the second movement, and/or other movements from the set of movements.

In some embodiments, generating the workout routine includes configuring the workout routine based upon at least one of a set period of time, a number of rounds, a number of repetitions (reps) or a total time required to finish the workout routine. For example, the workout routine can be configured based upon the total time required for the user to complete 4 rounds (e.g., a round consist of 10 reps of the first movement and 10 reps of the second movement). Alternatively, the workout routine can be configured to so that the user can be instructed to complete as many rounds as possible in a set period of time. In some embodiments, the set period of time can be about 1 minute to about 60 minutes or any other time period.

In some embodiments, generating the workout routine from the set of movements may also include setting an exertion level for the user. In some embodiments, the exertion level can be based upon a user profile. The user profile may include a historical performance of the user for one or more of the movements. For example, the user can input into the user profile the one rep max or any other metric (e.g., a maximum number of reps, a running distance, a swimming distance or time, a mile running time, etc.) for at least one of the first movement or the second movement. The one rep max can then be used to determine a target weight for a given number of reps. By way of example, if the workout routine utilizes 5 reps of the first movement, the exertion level for the user may be calculated based upon 70% of the weight used for the users 1 rep max for the first movement. In some embodiments, the exertion level may be set based upon a historical result for the first movement, the second movement, and/or other movements. For example, if the user previously performed 10 reps of the first movement at a given weight, the exertion level for performing 10 reps of the first movement can be set based upon the given weight used when the user previously performed the first movement. In some embodiments, the exertion level is at least one of a weight to rep ratio or a weight to time ratio. In some embodiments, the exertion level is based upon a workout group into which the user is grouped (e.g., a fitness group with which the user is a member; a group of users having similar fitness levels; etc.)

In some embodiments, a result of at least one of the first movement, the second movement or the workout routine is tracked. In some embodiments, the result is inputted into the user profile. In some embodiments, the result provides the historical result used to calculate the users exertion level. In some embodiments, at least one of the weight, time or number of round of the workout routine is tracked. In some embodiments, the user can input notes regarding the workout routine or movement. In some embodiments, the notes can include an indication of whether the exertion level should be increased or decreased. In some embodiments, the result is shared though at least one of a social media network, a website, a leaderboard, a microblog message, or an email.

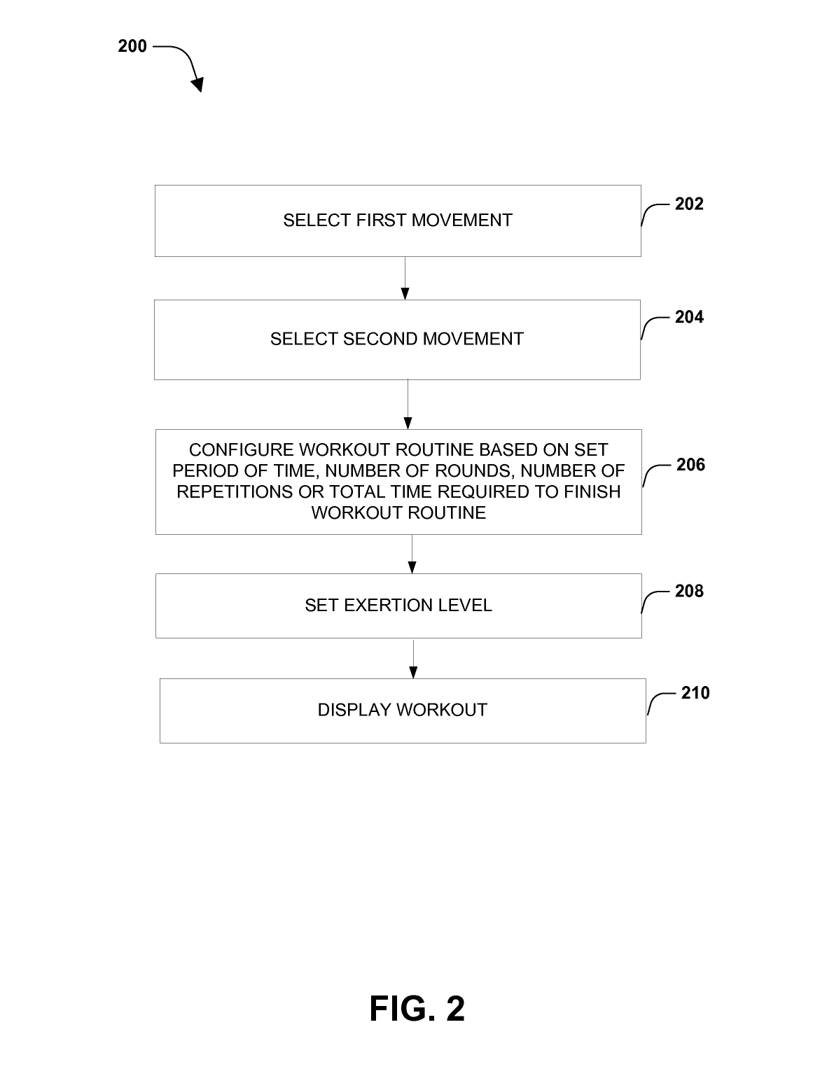

FIG. 2 illustrates a method 200 of generating a workout routine from a set of movements. At 202, the first movement is selected from the set of movements. In some embodiments, the first movement is selected by the user or at random. At 204, the second movement may be selected from the set of movements. In some embodiments, the workout routine is generated based upon the first movement, the second movement, and/or other movements. At 206, the workout routine is configured based upon at least one of a set period of time, a number of rounds, a number of reps or a total time required to finish the workout routine. For example, the workout routine can be configured so that the user will perform 4 rounds, where respective rounds contain 5 reps of the first movement and 10 reps of the second movement. At 208, an exertion level is set for the workout routine. For example, if the workout routine includes performing 5 reps of the first movement, the weight for the first movement in the workout routine may be set at 80% of the 5 rep max for the user. At 210, the workout routine is displayed to the user. In some embodiments, the workout routine can be displayed on a device (e.g. computer, cell phone, tablet, watch, etc.).

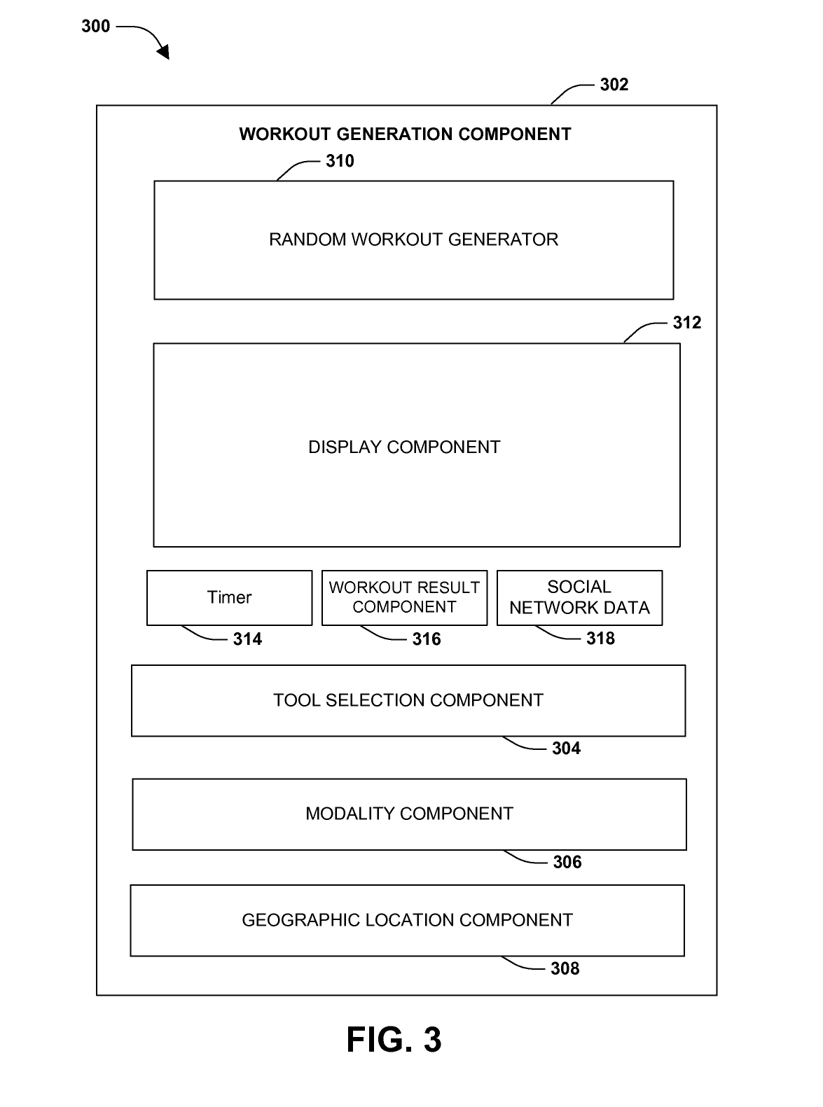

FIG. 3 illustrates an example of a system 300 for generating a workout routine. The system 300 may include a workout generator component 302. The workout generator component may be configured to provide the workout routine. The workout generator component 302 may be configured to receive at least one of the first input, the second input or the third input. In some embodiments, at least one of the first input, the second input or the third input includes at least one of a first tool, a second tool, a modality or a geographic location.

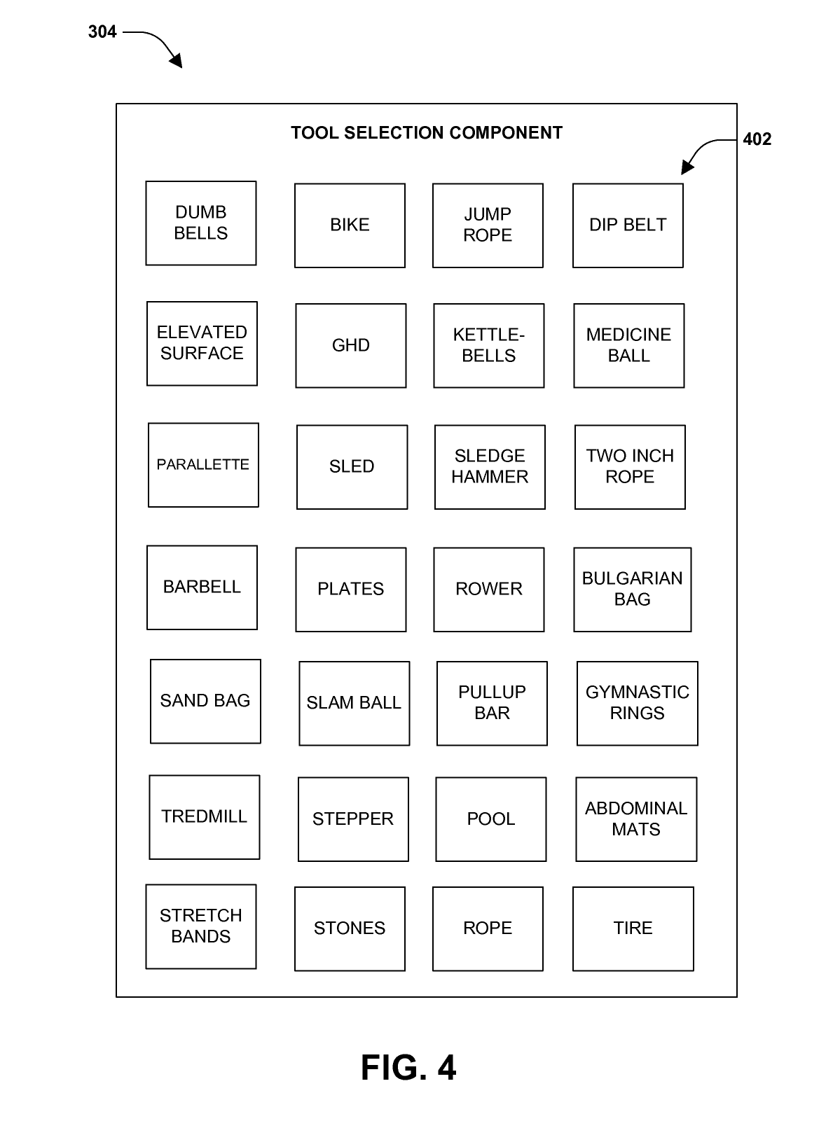

The workout generator component 302 may be configured to provide a tool selection component 304 through which the user of the workout generator component 302 may input at least one of the first tool or the second tool. In some embodiments, the tool selection component 304 includes a graphical selection interface 402 of selecting at least one of the tools available to a user, as illustrated in FIG. 4. In some embodiments, the graphical selection interface 402 includes the tools that may be available to the user for use in the workout routine.

The workout generator component 302 may also be configured to provide a modality component 306 through which the user of the workout generator 302 may input the modality. The workout generator component 302 may be configured to provide a geographic location component 308 through which the user of the workout generator component 302 may input the geographic location.

The workout generator component 302 may also be configured to provide a random workout generator 310 through which the user can generate various different workout routines. In some embodiments, the random workout generator 310 can be operatively configured to cycle through different workout routines until a desired workout routine is selected. The workout generator component 302 may be configured to provide a display component 312 by which the work out routines can be displayed to the user.

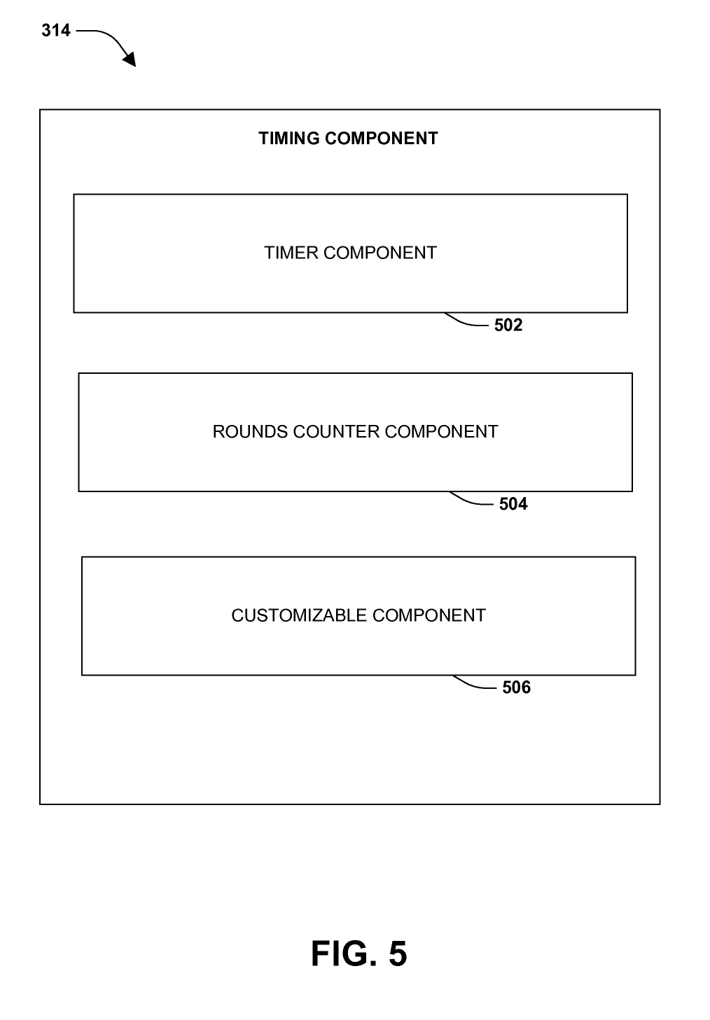

The workout generator component 302 may utilize a timing component 314 to facilitate tracking the results of the workout routine. In some embodiments, the timing component 314 may include a timer component 502, a rounds counter component 504 and/or a customizable component 506, as illustrated in FIG. 5. In some embodiments, the rounds counter component 504 includes an interface that the user can actuate during the workout routine to keep track of the number of rounds completed. In another embodiment, the customizable component 506 can be configured to indicate to the user when to perform a movement and when to rest, such as in a TABATA sequence (e.g. 4 minute workout with intervals of 20 seconds performing a movement and 10 seconds of rest).

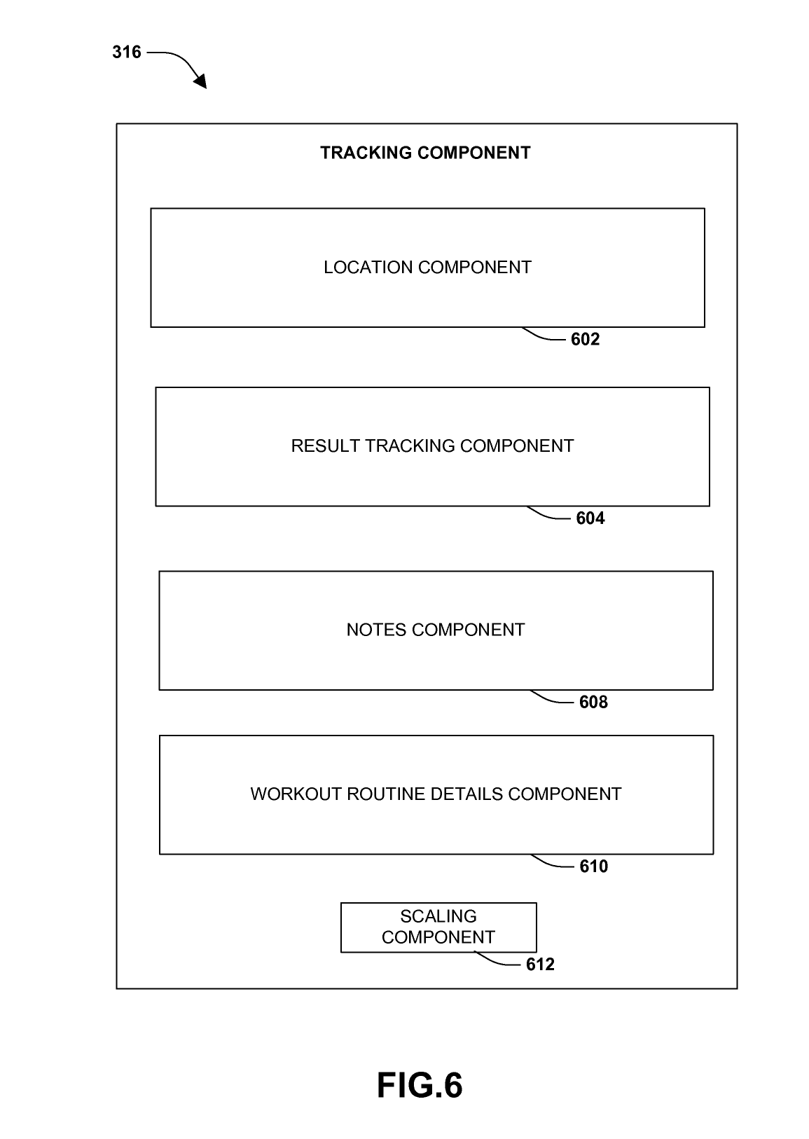

The workout generation component 302 may be configured to maintain a workout result data in a workout result component 316. The workout results component 316 may also be configured to maintain the user profile. The workout result component 316 may be configured to track results, progress and/or goals of the user and upload the corresponding data to the user profile. In some embodiments, the workout results component 316 may include at least one of a location component 602, a results tracking component 604, a notes component 608, a workout routine details component 610, and/or a scaling component 612, as illustrated in FIG. 6. In some embodiments, the location component 602 is configured to maintain the location where the workout routine was performed. In some embodiments, the results tracking component 604 is configured to maintain at least one of the weight, time or number of round corresponding to the workout routine. In some embodiments, the notes component 608 is configured to maintain comments about a given workout or movement. In some embodiments, the scaling component 612 is configured to indicate whether the user performed a movement at the suggest weight or if the user increased or decreased the weight.

The workout generator component 302 may maintain social network data 318 through which the user of the workout generator may interact and/or share information. In some embodiments, the social network data 318 can be configured to share data from the workout results component.

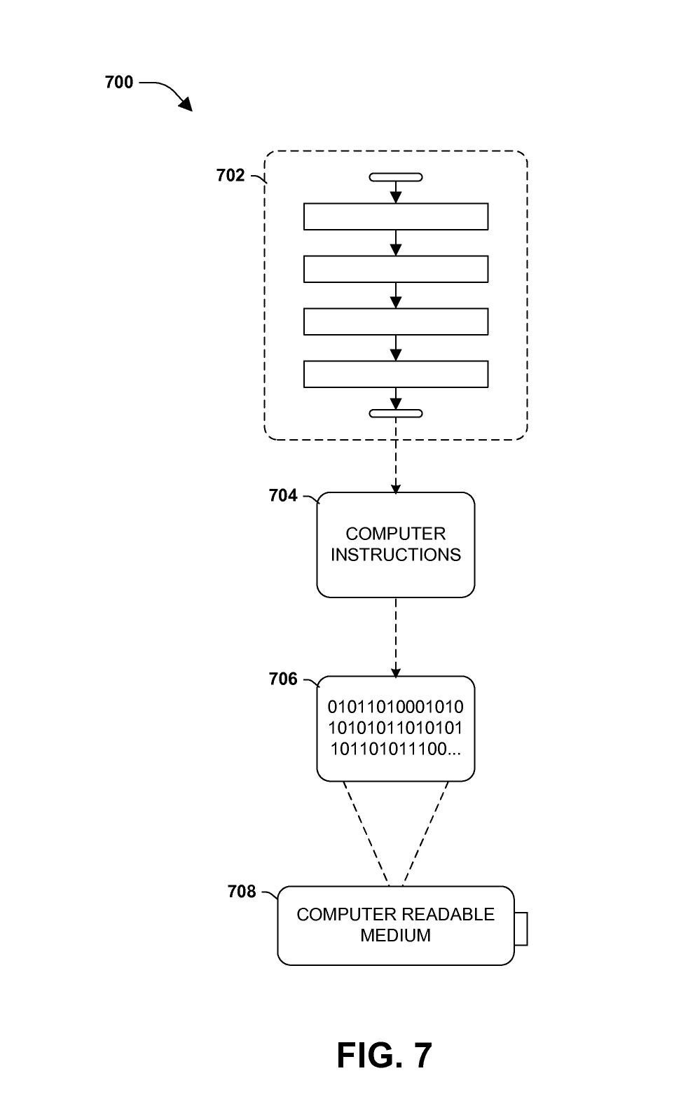

Still another embodiment involves a computer-readable medium comprising processor-executable instructions configured to implement one or more of the techniques presented herein. An example embodiment of a computer-readable medium or a computer-readable device is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1 and/or the exemplary method 200 of FIG. 2, for example. In some embodiments, the processor-executable instructions 704 are configured to implement a system, such as at least some of the exemplary system 300 of FIG. 3, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

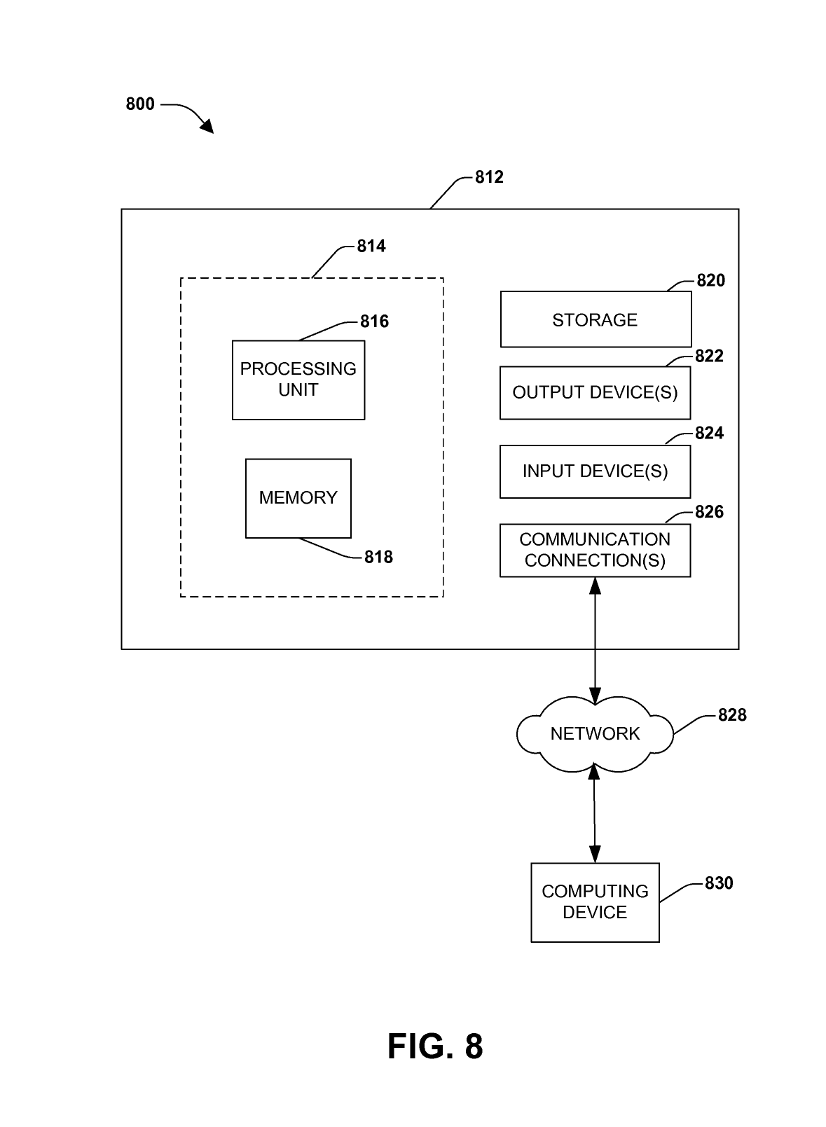

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 10 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 830 accessible via a network 818 may store computer readable instructions to implement one or more embodiments provided herein. Computing device 802 may access computing device 830 and download a part or all of the computer readable instructions for execution. Alternatively, computing device 802 may download pieces of the computer readable instructions, as needed, or some instructions may be executed at computing device 802 and some at computing device 830.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for generating a workout routine, comprising:
receiving a first input comprising a first tool available to a user;
generating a set of movements based upon the first tool; and
generating a workout routine based upon the set of movements.

2. The method of claim 1, the first input comprising a second tool available to the user, and the generating a set of movements comprising:
generating the set of movements based upon the second tool.

3. The method of claim 1, the generating a workout routine comprising:
generating the workout routine based upon a selection of a first movement and a second movement from the set of movements.

4. The method of claim 1, the generating the workout routine comprising:
generating the workout routine based upon a randomized selection of at least one of a first movement or a second movement from the set of movements.

5. The method of claim 1, the generating the workout routine comprising:
configuring the workout routine based upon at least one of a set period of time, a number of rounds, a number of reps or a total time required to finish the workout routine.

6. The method of claim 1, comprising:
receiving a second input comprising a modality; and
generating the set of movements based upon the modality.

7. The method of claim 6, the modality comprising at least one of:
a gymnastic movement, a weightlifting movement, or a metabolic movement.

8. The method of claim 1, comprising:
tracking a result of one or more movements within the set of movements.

9. The method of claim 8, comprising:
sharing the result through at least one of a social network, a website, a leaderboard, a microblog message, or an email.

10. The method of claim 1, the generating the workout routine comprising:
setting an exertion level for the user based upon a user profile or a historical result for one or more movements within the set of movements; and
generate the workout routine based upon the exertion level.

11. The method of claim 1, the first tool comprising at least one of a dumb bell, bike, jump rope, dip belt, elevated surface, kettlebell, medicine ball, parallettes, sled, sledge hammer, rope, barbell, plates, rower, Bulgarian bag, sand bag, slam ball, pullup bar, gymnastic rings, stretch bands, abdominal mats, stones, or glute-ham developer (GHD).

12. A system for generating a workout routine, comprising:
a workout generator component configured to:
receive a first input comprising a first tool available to a user;
receive a second input comprising at least one of a second tool, a modality or a geographic location;
generate a set of movements based upon the first tool and at least one of the modality of the geographic location; and
generate a workout routine based upon the set of movements.

13. The system of claim 12, the first input comprising a second tool available to the user, and the workout generator component configured to:
generate the set of movements based upon the second tool.

14. The system of claim 12, the workout generator component configured to:
generate the workout routine based upon a randomized selection of at least one of a first movement or a second movement from the set of movements.

15. The system of claim 12, the workout generator component configured to:
configure the workout routine based on at least one of a set period of time, a number of rounds, a number of reps or a total time required to finish the workout routine.

16. The system of claim 12, the modality comprising at least one of:
a gymnastic movement, a weightlifting movement, or metabolic movement.

17. The system of claim 12, comprising:
a workout result component configured to:
track a result of one or more movements within the set of movements.

18. The system of claim 12, the workout result component configured to:
share the result through at least one of a social network, a website, a leaderboard, a microblog message, or an email.

19. The system of claim 12, the workout generator component configured to:
set an exertion level for user the based upon at least one of a user profile or a historical result for one or more movements within the set of movements; and
generate the workout routine based upon the exertion level.

20. A computer readable medium comprising instructions that when executed perform a method for generating a workout routine, comprising:
receiving a first input comprising a first tool available to a user;
receiving a second input comprising a modality;
generating a set of movements based upon the first tool and the modality;
generating a workout routine based upon the set of movements.
